(19) United States
(12) Patent Application Publication
(10) Pub. No.: US 2023/0079114 A1
(43) Pub. Date: Mar. 16, 2023

(54) PNEUMATIC TIRE

(71) Applicant: The Yokohama Rubber Co., LTD., Tokyo (JP)

(72) Inventor: Masahiro NARUSE, Kanagawa (JP)

(21) Appl. No.: 17/904,117

(22) PCT Filed: Feb. 12, 2021
(86) PCT No.: PCT/JP2021/005211

§ 371 Date: Aug. 12, 2022

(30) Foreign Application Priority Data
Feb. 17, 2020 (JP) 2020-024642
Feb. 17, 2020 (JP) 2020-024643

(51) Int. Cl. B60C 15/06; B60C 19/00

(52) U.S. Cl. CPC B60C 15/06; B60C 19/00; B60C 2019/004

(57) ABSTRACT

Provided is a pneumatic tire. A transponder is embedded in an outer side in a tire width direction of a carcass layer, the transponder is covered by a covering layer, and a storage modulus E′c at 20° C. of the covering layer and a storage modulus E′out at 20° C. of a rubber member having the largest storage modulus at 20° C. of rubber members located on an outer side in the tire width direction of the transponder satisfy the relationship 0.1≤E′c/E′out≤1.5. Further, the storage modulus E′c at 20° C. of the covering layer and a storage modulus E′in at 20° C. of a rubber member having the largest storage modulus at 20° C. of rubber members located on an inner side in the tire width direction of the transponder satisfy the relationship 0.03≤E′c/E′in≤1.50.

### TECHNICAL FIELD

The present technology relates to a pneumatic tire in which a transponder covered with a covering layer is embedded and relates particularly to a pneumatic tire in which the communication performance and durability of the transponder can be improved while improving the durability of the tire.

### BACKGROUND ART

A pneumatic tire in which an RFID (radio frequency identification) tag (transponder) is embedded therein has been proposed (see, for example, Japan Unexamined Patent PublicationNo. H07-137510). Embedding a transponder in the tire causes stress concentration in these members due to tire deformation when a difference in rigidity between a covering layer covering the transponder and a rubber member around the covering layer is large, leading to the damage of the transponder or the degradation of durability of the tire. Further, disposing the transponder in an inner side in a tire width direction of a carcass layer causes a radio wave to be blocked by a tire component (for example, a steel carcass) during communication of the transponder, degrading the communication performance of the transponder.

### SUMMARY

The present technology provides a pneumatic tire in which the communication performance and durability of the transponder can be improved while improving the durability of the tire.

A pneumatic tire according to a first embodiment of the technology includes a tread portion extending in a tire circumferential direction and having an annular shape, a pair of sidewall portions disposed on both sides of the tread portion, a pair of bead portions disposed on inner sides in a tire radial direction of the pair of sidewall portions, and a carcass layer mounted between the pair of bead portions. In the pneumatic tire, a transponder is embedded in an outer side in a tire width direction of the carcass layer, the transponder is covered with a covering layer, and a storage modulus E′c (20° C.) at 20° C. of the covering layer and a storage modulus E′out (20° C.) at 20° C. of a rubber member having the largest storage modulus at 20° C. of rubber members located on an outer side in the tire width direction of the transponder satisfy a relationship 0.1≤E′c (20° C.)/E′out (20° C.)≤1.5.

A pneumatic tire according to a second embodiment of the technology includes a tread portion extending in a tire circumferential direction and having an annular shape, a pair of sidewall portions disposed on both sides of the tread portion, a pair of bead portions disposed on inner sides in a tire radial direction of the pair of sidewall portions, and a carcass layer mounted between the pair of bead portions. In the pneumatic tire, a transponder is embedded in an outer side in a tire width direction of the carcass layer, the transponder is covered with a covering layer, and a storage modulus E′c (20° C.) at 20° C. of the covering layer and a storage modulus E′in (20° C.) at 20° C. of a rubber member having the largest storage modulus at 20° C. of rubber members located on an inner side in the tire width direction of the transponder satisfy a relationship 0.03≤E′c (20° C.)/E′in (20° C.)≤1.50.

The embodiment of the first technology, which has the transponder embedded in the outer side in the tire width direction of the carcass layer, has no tire component that blocks radio waves during communication of the transponder, ensuring the communication performance of the transponder. In addition, the transponder is covered with the covering layer, and the storage modulus E′c (20° C.) at 20° C. of the covering layer and the storage modulus E′out (20° C.) at 20° C. of the rubber member having the largest storage modulus at 20° C. of the rubber members located on the outer side in the tire width direction of the transporter satisfy the relationship described above. Thus, the difference in rigidity between the covering layer and the rubber members located on the outer side of the transponder is unlikely to be excessively large, enabling the rigidity of the covering layer with respect to the rubber members to be appropriately maintained. This can improve the durability of the tire and that of the transponder.

The embodiment of the second technology, which has the transponder embedded in the outer side in the tire width direction of the carcass layer, has no tire component that blocks radio waves during communication of the transponder, ensuring the communication performance of the transponder. In addition, the transponder is covered with the covering layer, and the storage modulus E′c (20° C.) at 20° C. of the covering layer and the storage modulus E′in (20° C.) at 20° C. of the rubber member having the largest storage modulus at 20° C. of the rubber members located on the inner side in the tire width direction of the transponder satisfy the relationship described above. Thus, the difference in rigidity between the covering layer and the rubber members located on the inner side of the transponder is unlikely to be excessively large, enabling the rigidity of the covering layer with respect to the rubber members to be appropriately maintained. This can improve the durability of the tire and that of the transponder.

The pneumatic tire according to the embodiment of the first technology or the embodiment of the second technology preferably has the storage modulus E′c (20° C.) at 20° C. of the covering layer ranging from 2 MPa to 12 MPa. This can effectively improve the durability of the transponder.

The covering layer preferably has a relative dielectric constant of 7 or less. This enables the transponder to have a radio wave transmitting property, effectively improving the communication performance of the transponder.

The covering layer is preferably formed of rubber or elastomer and 20 phr or more of white filler. This enables the relative dielectric constant of the covering layer to be relatively small and effectively improve the communication performance of the transponder.

The white filler preferably includes 20 phr to 55 phr of calcium carbonate. This enables the relative dielectric constant of the covering layer to be relatively small and effectively improve the communication performance of the transponder.

The center of the transponder is preferably disposed 10 mm or more spaced from a splice portion of a tire component in the tire circumferential direction. This can effectively improve the tire durability.

The transponder is preferably disposed between a position 15 mm on an outer side in the tire radial direction of an upper end of a bead core of a bead portion and a tire maximum width position. This causes the transponder to be disposed in a region where the stress amplitude is low during traveling and thus can effectively improve the durability of the transponder.

A distance between a cross-sectional center of the transponder and a tire outer surface is preferably 2 mm or more. This can effectively improve the tire durability and can improve the tire scratch resistance.

The thickness of the covering layer preferably ranges from 0.5 mm to 3.0 mm. This can effectively improve the communication performance of the transponder without making the tire outer surface uneven.

Preferably, the transponder includes an IC substrate for storing data and an antenna for transmitting and receiving data, and the antenna has a helical shape. This allows the antenna to follow the deformation of the tire during traveling, improving the durability of the transponder.

In the embodiment of the first technology and the embodiment of the second technology, the storage modulus E′ is measured in accordance with JIS (Japanese Industrial Standard)-K6394 by using a viscoelastic spectrometer under specified temperatures, a frequency of 10 Hz, an initial strain of 10%, and a dynamic strain of ±2% in a tensile deformation mode.

### BRIEF DESCRIPTION OF DRAWINGS

FIG. 1 is a meridian cross-sectional view illustrating a pneumatic tire according to an embodiment of the present technology.

FIG. 2 is a meridian cross-sectional view schematically illustrating the pneumatic tire of FIG. 1.

FIG. 3 is an equator line cross-sectional view schematically illustrating the pneumatic tire of FIG. 1.

FIG. 4 is an enlarged cross-sectional view illustrating a transponder embedded in the pneumatic tire of FIG. 1.

FIGS. 5A and 5B are perspective views each illustrating a transponder that can be embedded in a pneumatic tire according to an embodiment of the present technology.

FIG. 6 is an explanatory diagram illustrating a position in a tire radial direction of a transponder in a test tire.

### DETAILED DESCRIPTION

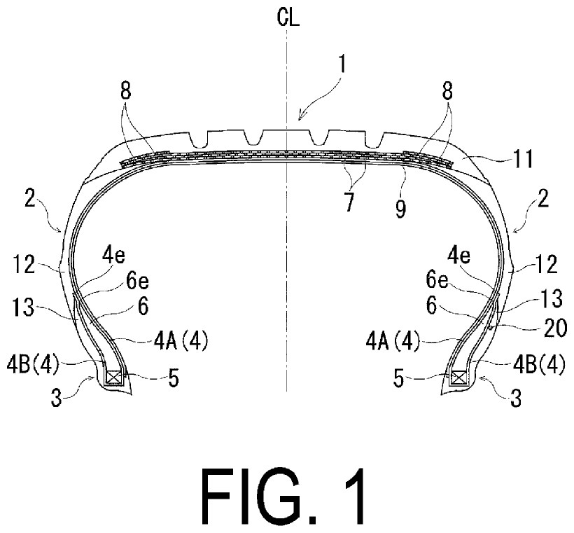

A configuration of an embodiment of the first technology will be described in detail below with reference to the accompanying drawings. FIGS. 1 to 4 illustrate a pneumatic tire according to an embodiment of the present technology.

As illustrated in FIG. 1, a pneumatic tire according to the present embodiment includes a tread portion 1 extending in a tire circumferential direction and having an annular shape, a pair of sidewall portions 2 disposed on both sides of the tread portion 1, and a pair of bead portions 3 disposed on inner sides in a tire radial direction of the pair of sidewall portions 2.

At least one carcass layer 4 (one layer in FIG. 1) formed by arranging a plurality of carcass cords in the radial direction is mounted between the pair of bead portions 3. The carcass layer 4 is covered with rubber. Organic fiber cords of nylon, polyester, or the like are preferably used as the carcass cords forming the carcass layer 4. A bead core 5 having an annular shape is embedded in each of the bead portions 3, and a bead filler 6 made of a rubber composition and having a triangular cross-section is disposed on a periphery of the bead core 5.

On the other hand, a plurality of belt layers 7 (two layers in FIG. 1) is embedded in a tire outer circumferential side of the carcass layer 4 in the tread portion 1. The belt layers 7 includes a plurality of reinforcing cords inclined with respect to the tire circumferential direction, and the reinforcing cords are disposed between the layers intersecting with each other. In the belt layers 7, the inclination angle of each of the reinforcing cords with respect to the tire circumferential direction is set to a range of, for example, 10° to 40°. Steel cords are preferably used as the reinforcing cords of the belt layers 7.

To improve high-speed durability, at least one belt cover layer 8 (two layers in FIG. 1) formed by arranging the reinforcing cords at an angle of, for example, 5° or less with respect to the tire circumferential direction is disposed on a tire outer circumferential side of the belt layers 7. In FIG. 1, the belt cover layer 8 located on an inner side in the tire radial direction forms a full cover that covers the entire width of the belt layers 7, and the belt cover layer 8 located on an outer side in the tire radial direction forms an edge cover layer that covers only end portions of the belt layers 7. Organic fiber cords of nylon, aramid, or the like are preferably used as the reinforcing cords of the belt cover layer 8.

In the pneumatic tire described above, two ends 4e of the carcass layer 4 are each folded back from an inner side to an outer side of the tire around the bead core 5 and are disposed wrapping around the bead core 5 and the bead filler 6. The carcass layer 4 includes a body portion 4A corresponding to a portion ranging from the tread portion 1 through each of the sidewall portions 2 to a corresponding one of the bead portions 3 and a turned up portion 4B corresponding to a portion turned up around the bead core 5 at each of the bead portions 3 and extending toward a side of each of the sidewall portions 2.

Additionally, a tire inner surface includes an innerliner layer 9 along the carcass layer 4. The tread portion 1 includes a cap tread rubber layer 11, the sidewall portion 2 includes a sidewall rubber layer 12, and the bead portion 3 includes a rim cushion rubber layer 13.

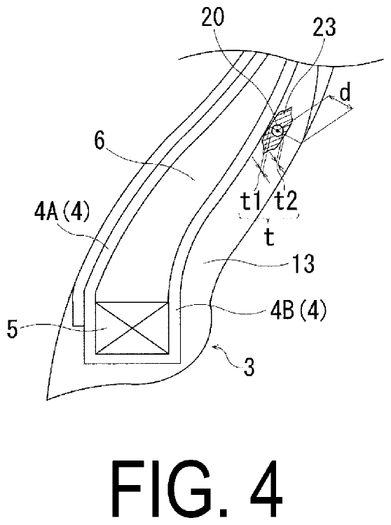

Additionally, the pneumatic tire described above includes a transponder 20 embedded in a portion on an outer side in the tire width direction of the carcass layer 4. The transponder 20 extends along the tire circumferential direction. The transponder 20 may be disposed inclined at an angle ranging from −10° to 10° with respect to the tire circumferential direction. As illustrated in FIG. 4, the transponder 20 is covered with a covering layer 23. The covering layer 23 covers all of the transponder 20 while holding both front and back surfaces of the transponder 20. The covering layer 23 may be formed of rubber having physical properties identical to those of rubber forming the sidewall rubber layer 12 or the rim cushion rubber layer 13 or formed of rubber having different physical properties.

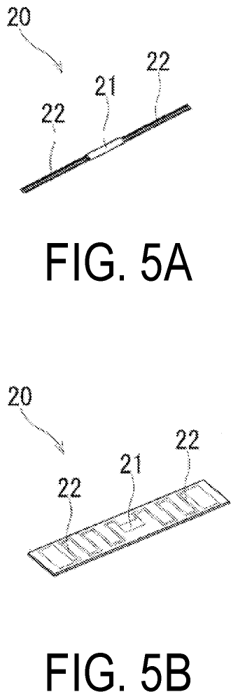

As the transponder 20, for example, a radio frequency identification (RFID) tag may be used. As illustrated in FIGS. 5A and 5B, the transponder 20 includes an IC substrate 21 for storing data and an antenna 22 for transmitting and receiving data in a non-contact manner. The transponder 20 as described above allows for timely writing or reading information on the tire and efficiently managing the tire. Note that the RFID is an automatic recognition technology that includes a reader/writer having an antenna and a controller and an ID (identification) tag having an IC (integrated circuit) substrate and an antenna and allows for wirelessly communicating data.

The overall shape of the transponder 20 is not particularly limited but may be, for example, a pillar shape or plate-like shape, as illustrated in FIGS. 5A and 5B. In particular, the transponder 20 having a pillar shape illustrated in FIG. 5A can suitably follow deformation of the tire in each direction. In this case, the antennas 22 of the transponder 20 each project from both end portions of the IC substrate 21 and have a helical shape. This allows the transponder 20 to follow deformation of the tire during traveling, thus improving the durability of the transponder 20. Furthermore, appropriately changing the lengths of the antennas 22 ensures the communication performance.

In the pneumatic tire having such a configuration, of rubber members located on an outer side in the tire width direction of the transponder 20 (the sidewall rubber layer 12 and the rim cushion rubber layer 13 in FIG. 1), a rubber member having the largest storage modulus E′out(20° C.) at 20° C. (hereinafter sometimes referred to as an outer member) corresponds to the rim cushion rubber layer 13. Note that the rubber member having the largest storage modulus at 20° C. (outer member) does not include the covering layer 23 covering the transponder 20.

Here, the storage modulus E′out (20° C.) at 20° C. of the outer member and the storage modulus E′c (20° C.) at 20° C. of the covering layer 23 satisfy the relationship 0.1≤E′c (20° C.)/E′out (20° C.)≤1.5. In particular, it is preferable to satisfy the relationship 0.15≤E′c (20° C.)/E′out (20° C.)≤1.30.

Note that the embodiment of FIG. 1 illustrates an example in which the transponder 20 is disposed between the turned up portion 4B of the carcass layer 4 and the rim cushion rubber layer 13, but embodiments are not limited thereto. The transponder 20 can also be disposed between the body portion 4A of the carcass layer 4 and the sidewall rubber layer 12. The outer member varies depending on the disposition position of the transponder 20, but in any case, the storage modulus E′c (20° C.) at 20° C. of the covering layer 23 and the storage modulus E′out (20° C.) at 20° C. of the outer member are set to satisfy the relationship described above.

The pneumatic tire described above, which has the transponder 20 embedded in the outer side in the tire width direction of the carcass layer 4, has no tire component that blocks radio waves during communication of the transponder 20, ensuring the communication performance of the transponder 20. Additionally, the transponder 20 is covered with the covering layer 23, and the storage modulus E′c (20° C.) at 20° C. of the covering layer 23 and the storage modulus E′out (20° C.) at 20° C. of the rubber member having the largest storage modulus at 20° C. of the rubber members located on the outer side in the tire width direction of the transponder 20 satisfy the relationship 0.1≤E′ c (20° C.)/E′out (20° C.)≤1.5. Thus, the difference in rigidity between the covering layer 23 and the rubber members located on the outer side of the transponder 20 is unlikely to be excessively large, enabling the rigidity of the covering layer 23 with respect to the rubber members to be appropriately maintained. This can improve the durability of the tire and that of the transponder 20.

Here, in a case where the value of E′c (20° C.)/E′out (20° C.) is smaller than the lower limit value, the covering layer 23 is excessively softer than the outer member, the covering layer 23 is thus compressed when the outer member is bent due to tire deformation, and the transponder 20 is likely to be damaged. Conversely, in a case where the value of E′c (20° C.)/E′out (20° C.) is greater than the upper limit value, stress concentration occurs at an end portion of the covering layer 23 during tire deformation, and repeated shearing deformation causes peeling to be likely to occur at an interface between the covering layer 23 and the rubber members adjacent to the covering layer 23.

Of rubber members located on an inner side in the tire width direction of the transponder 20 (coating rubber of the carcass layer 4, the bead filler 6, and the innerliner layer 9 in FIG. 1), a rubber member having the largest storage modulus E′in (20° C.) at 20° C. (inner member) corresponds to the bead filler 6. To enhance the protection of the transponder 20 against tire deformation during traveling, the physical properties of the inner member and those of the outer member preferably satisfy the relationship 0.01×E′c (20° C.)/E′out(20° C.)≤E′c (20° C.)/E′in (20° C.)≤7.5×E′c (20° C.)/E′out (20° C.). In particular, in a case where the JIS hardness at 20° C. of the inner member is relatively high, it is preferable to satisfy the relationship 0.01×E′c (20° C.)/E′out (20° C.)≤E′c (20° C.)/E′in (20° C.)≤1.2×E′c (20° C.)/E′out(20° C.), and it is more preferable to satisfy the relationship 0.01×E′c (20° C.)/E′out (20° C.)≤E′c (20° C.)/E′in (20° C.)≤1.0×E′c (20° C.)/E′out (20° C.). In this case, deformation is small, effectively preventing the damage to the transponder 20. Furthermore, in a case where the JIS hardness at 20° C. of the inner member is relatively low, it is preferable to satisfy the relationship 0.6×E′c (20° C.)/E′out (20° C.)≤E′c (20° C.)/E′in (20° C.)≤7.5×E′c (20° C.)/E′out (20° C.), and it is more preferable to satisfy the relationship 0.6×E′c (20° C.)/E′out (20° C.)≤E′c (20° C.)/E′in (20° C.)≤6.5×E′c (20° C.)/E′out (20° C.). In this case, stress concentration is unlikely to occur, and tire durability is effectively improved. Note that the rubber member having the largest storage modulus at 20° C. (inner member) does not include the covering layer 23 covering the transponder 20.

In the pneumatic tire described above, the storage modulus E′c (20° C.) at 20° C. of the covering layer 23 is preferably in the range of from 2 MPa to 12 MPa. Setting the physical properties of the covering layer 23 as described above allows the durability of the transponder 20 to be effectively improved.

The storage modulus E′c (20° C.) at 20° C. of the covering layer 23 and the storage modulus E′c (60° C.) at 60° C. of the covering layer 23 preferably satisfy the relationship 1.0≤E′c (20° C.)/E′c (60° C.)≤1.5. Setting the physical properties of the covering layer 23 as described above lowers the temperature dependence of the covering layer 23 (the covering layer 23 is less likely to heat up) and does not soften the covering layer 23 when the temperature of the tire rises during high-speed traveling, allowing the durability of the transponder 20 to be effectively improved.

The storage modulus E′c (60° C.) at 60° C. of the covering layer 23 and the storage modulus E′a (60° C.) at 60° C. of a rubber member adjacent on an outer side in the tire width direction of the covering layer 23 (the rim cushion rubber layer 13 in FIG. 4) preferably satisfy the relationship 0.2≤E′c (60° C.)/E′a (60° C.)≤1.2. Setting the physical properties of the covering layer 23 and the rubber member adjacent to the covering layer 23 as described above brings the physical properties of both closer, obtaining the effect of dispersing stress during traveling and allowing the durability of the transponder 20 to be effectively improved.

The covering layer 23 is preferably formed of rubber or elastomer and 20 phr or more of white filler. The covering layer 23 thus formed can reduce the relative dielectric constant of the covering layer 23, compared to the covering layer 23 containing carbon, and can effectively improve the communication performance of the transponder 20. Note that in the present Specification, “pfr” means parts by weight per 100 parts by weight of a rubber component (elastomer).

The white filler forming the covering layer 23 preferably includes from 20 phr to 55 phr of calcium carbonate. This can reduce the relative dielectric constant of the covering layer 23 and effectively improve the communication performance of the transponder 20. However, the white filler containing too much of calcium carbonate becomes vulnerable and reduces the strength of the covering layer 23, and this is not preferable. Furthermore, the covering layer 23 can optionally include 20 phr or less of silica (white filler) or 5 phr or less of carbon black in addition to calcium carbonate. A small amount of a silica or carbon black used in combination can reduce the relative dielectric constant of the covering layer 23 while ensuring the strength thereof.

The relative dielectric constant of the covering layer 23 is preferably 7 or less, and more preferably from 2 to 5. Properly setting the relative dielectric constant of the covering layer 23 as described above ensures radio wave transmitting property during emission of radio waves by the transponder 20, allowing the communication performance of the transponder 20 to be effectively improved. Note that the rubber forming the covering layer 23 has a relative dielectric constant of from 860 MHz to 960 MHz at ambient temperature. Here, the ambient temperature is 23±2° C. and 60%±5% RH (relative humidity) in accordance with the standard conditions of the JIS system. The relative dielectric constant of the rubber is measured according to an electrostatic capacitance method after a 24-hour treatment at 23° C. and 60% RH. The range from 860 MHz to 960 MHz described above corresponds to the allocated frequency of the RFID in the current UHF (ultra-high frequency) band, but in a case where the allocated frequency is changed, it is only required that the relative dielectric constant in the range of the allocated frequency be specified as described above.

Additionally, the thickness of the covering layer 23 is preferably from 0.5 mm or more and 3.0 mm or less, and more preferably 1.0 mm or more and 2.5 mm or less. Here, a thickness t of the covering layer 23 is a rubber thickness at a position including the transponder 20, and is, for example, a rubber thickness obtained by summing a thickness t1 and a thickness t2 on a straight line extending through the center of the transponder 20 and orthogonally to a tire outer surface, as illustrated in FIG. 4. Properly setting the thickness t of the covering layer 23 as described above allows the communication performance of the transponder 20 to be effectively improved without making the tire outer surface uneven. Here, the thickness t of the covering layer 23 being less than 0.5 mm fails to obtain the effect of improving the communication performance of the transponder 20. In contrast, the thickness t of the covering layer 23 exceeding 3.0 mm makes the tire outer surface uneven, and this is not preferable for appearance. Note that the cross-sectional shape of the covering layer 23 is not particularly limited and that for example, a triangular shape, a rectangular shape, a trapezoidal shape, and a spindle shape can be adopted. The covering layer 23 in FIG. 4 has a cross-section having a substantially spindle-shape.

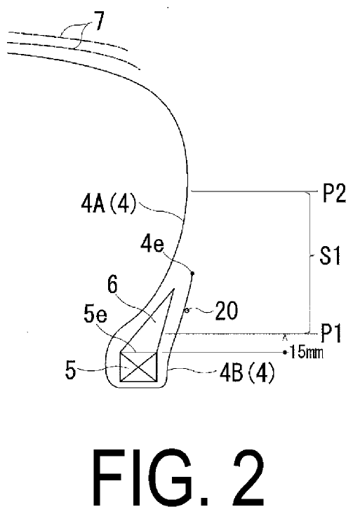

In the pneumatic tire described above, the transponder 20 is preferably disposed in an arrangement region in the tire radial direction between a position P1, which is 15 mm on an outer side in the tire radial direction of an upper end 5e of the bead core 5 (an end portion on an outer side in the tire radial direction), and a position P2 where the tire width is largest. In other words, the transponder 20 may be disposed in a region S1 illustrated in FIG. 2. The transponder 20 disposed in the region S1 is positioned in a region where the stress amplitude during traveling is small, and this can effectively improve the durability of the transponder 20, and further, does not reduce the durability of the tire. Here, the transponder 20 disposed on an inner side in the tire radial direction of the position P1 is brought closer to a metal member such as the bead core 5, and this tends to degrade the communication performance of the transponder 20. On the other hand, the transponder 20 disposed on an outer side in the tire radial direction of the position P2 is positioned in a region where the stress amplitude during traveling is large, and the breakage of the transponder 20 itself and the interfacial peeling in the periphery of the transponder 20 are likely to occur, and this is not preferable.

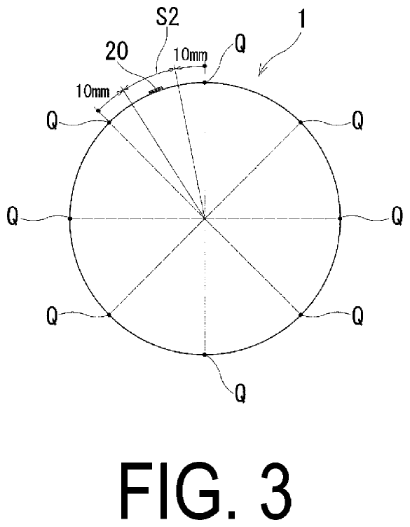

As illustrated in FIG. 3, a plurality of splice portions is on a tire circumference, the plurality of splice portions each being formed by overlaying end portions of a tire component. FIG. 3 illustrates positions Q of the splice portions in the tire circumferential direction. The center of the transponder 20 is preferably disposed 10 mm or more spaced from the splice portion of the tire component in the tire circumferential direction. In other words, the transponder 20 may be disposed in a region S2 illustrated in FIG. 3. Specifically, the IC substrate 21 forming the transponder 20 is preferably 10 mm or more spaced from the position Q in the tire circumferential direction. Furthermore, all of the transponders 20 including the antenna 22 are more preferably 10 mm or more spaced from the position Q in the tire circumferential direction, and all of the transponders 20 covered with the covering rubber are most preferably 10 mm or more spaced from the position Q in the tire circumferential direction. The tire component disposed spaced from the transponder 20 is preferably the sidewall rubber layer 12, the rim cushion rubber layer 13, or the carcass layer 4, which is disposed adjacent to the transponder 20. Thus, the transponder 20 is disposed spaced from the splice portion of the tire component, effectively improving the tire durability.

Note that while the embodiment of FIG. 3 illustrates an example in which the positions Q in the tire circumferential direction of the splice portions of the tire components are disposed at equal intervals, no such limitation is intended. The positions Q in the tire circumferential direction can be set anywhere, and in any case, the transponder 20 is disposed 10 mm or more spaced from the splice portion of the tire component in the tire circumferential direction.

As illustrated in FIG. 4, a distance d between the cross-sectional center of the transponder 20 and the tire outer surface is preferably 2 mm or more. Thus, the transponder 20 is spaced from the tire outer surface, effectively improving the tire durability and improving the tire scratch resistance.

While the embodiment described above illustrates an example in which the end 4e of the turned-up portion 4B of the carcass layer 4 is disposed at or near an upper end 6e of the bead filler 6, no such limitation is intended, and the end 4e of the turned-up portion 4B of the carcass layer 4 can be disposed at any height. For example, the end 4e of the turned-up portion 4B of the carcass layer 4 may be disposed on a side of the bead core 5. In such a low turn-up structure, the transponder 20 may be disposed between the bead filler 6 and the sidewall rubber layer 12 or the rim cushion rubber layer 13. In such a case, the rubber member adjacent on the outer side in the tire width direction of the covering layer 23 is the sidewall rubber layer 12 or the rim cushion rubber layer 13.

Now, a configuration of the second technology will be described. A pneumatic tire according to the second technology, as with the first technology, has a tire structure as illustrated in FIGS. 1 to 5(a) and (b).

In the pneumatic tire of the second technology, of the rubber members located on the inner side in tire width direction of the transponder 20 (coating rubber of the carcass layer 4, the bead filler 6, and the innerliner layer 9 in FIG. 1), a rubber member having the largest storage modulus E′in (20° C.) at 20° C. (hereinafter may be referred to as an inner member) corresponds to the bead filler 6. Note that the rubber member having the largest storage modulus at 20° C. (inner member) does not include the covering layer 23 covering the transponder 20.

Here, the storage modulus E′in at 20° C. of the inner member and the storage modulus E′c (20° C.) at 20° C. of the covering layer 23 satisfy the relationship 0.03≤E′c (20° C.)/E′in (20° C.)≤1.50. It is preferable, in particular, to satisfy the relationship 0.15≤E′c (20° C.)/E′in (20° C.)≤1.30.

Note that while the embodiment of FIG. 1 illustrates an example in which the transponder 20 is disposed between the turned up portion 4B of the carcass layer 4 and the rim cushion rubber layer 13, the present technology is not limited thereto. The transponder 20 can also be disposed between the body portion 4A of the carcass layer 4 and the sidewall rubber layer 12. The inner member varies depending on the disposition position of the transponder 20, but in any case, the storage modulus E′c (20° C.) at 20° C. of the covering layer 23 and the storage modulus E′in (20° C.) at 20° C. of the inner member are set to satisfy the relationship described above.

The pneumatic tire described above, which has the transponder 20 embedded in the outer side in the tire width direction of the carcass layer 4, has no tire component that blocks radio waves during communication of the transponder 20, ensuring the communication performance of the transponder 20. Also, the transponder 20 is covered with the covering layer 23, and the storage modulus E′c (20° C.) at 20° C. of the covering layer 23 and the storage modulus E′in (20° C.) at 20° C. of the rubber member having the largest storage modulus at 20° C. of the rubber members located on the inner side in the tire width direction of the transponder 20 satisfy the relationship 0.03≤E′c (20° C.)/E′in (20° C.)≤1.50. Thus, the difference in rigidity between the covering layer 23 and the rubber members located on the inner side of the transponder 20 is unlikely to be excessively large, enabling the rigidity of the covering layer 23 with respect to the rubber members to be appropriately maintained. This can improve the durability of the tire and that of the transponder 20.

Here, in a case where the value of E′c (20° C.)/E′in (20° C.) is smaller than the lower limit value, the inner member is harder than the covering layer 23, and the inner member is unlikely to be deformed, and the covering layer 23 being too soft reduces the protective effect thereof on the transponder 20, making the transponder 20 easily damageable. Conversely, in a case where the value of E′c (20° C.)/E′in (20° C.) is greater than the upper limit value, stress concentration occurs at the end portion of the covering layer 23 during tire deformation, and peeling is likely to occur at the interface between the covering layer 23 and the rubber members adjacent to the covering layer 23.

Of the rubber members located on the outer side in tire width direction of the transponder 20 (the sidewall rubber layer 12 and the rim cushion rubber layer 13 in FIG. 1), a rubber member having the largest storage modulus E′out (20° C.) at 20° C. (outer member) corresponds to the rim cushion rubber layer 13.

The physical properties of the outer member and those of the inner member preferably satisfy the relationship 0.1×E′c (20° C.)/E′in (20° C.)≤E′c (20° C.)/E′out (20° C.)≤75.0×E′c (20° C.)/E′in (20° C.), so as to increase the protection of the transponder 20 against tire deformation during traveling. In particular, in a case where the JIS hardness at 20° C. of the inner member is relatively high, it is preferable to satisfy the relationship 0.8×E′c (20° C.)/E′in (20° C.)≤E′c (20° C.)/E′out (20° C.) 75.0×E′c (20° C.)/E′in (20° C.), and it is more preferable to satisfy the relationship 0.95×E′c (20° C.)/E′in (20° C.)≤E′c (20° C.)/E′out (20° C.)≤64.0×E′c (20° C.)/E′in (20° C.). In this case, deformation is small, effectively preventing the damage to the transponder 20. Furthermore, when the JIS hardness at 20° C. of the inner member is relatively low, it is preferable to satisfy the relationship 0.1×E′c (20° C.)/E′in (20° C.)≤E′c (20° C.)/E′out (20° C.)≤40.0×E′c (20° C.)/E′in (20° C.), and it is more preferable to satisfy the relationship 0.15×E′c (20° C.)/E′in (20° C.)≤E′c (20° C.)/E′out (20° C.) 37.5×E′c (20° C.)/E′in (20° C.). In this case, stress concentration is unlikely to occur, and tire durability is effectively improved. Note that the rubber member having the largest storage modulus at 20° C. (outer member) does not include the covering layer 23 covering the transponder 20.

### EXAMPLE

Tires according to Comparative Examples 1 to 3 and Examples 1 to 11 were manufactured. The tires are pneumatic tires each having a tire size of 265/40ZR20 and including a tread portion extending in a tire circumferential direction and having an annular shape, a pair of sidewall portions disposed on both sides of the tread portion, a pair of bead portions disposed on inner sides in a tire radial direction of the sidewall portions, and a carcass layer mounted between the pair of bead portions. In the pneumatic tires, a transponder is embedded, the transponder is covered with a covering layer, and the position in a tire width direction of the transponder, the position in the tire radial direction of the transponder, E′c (20° C.)/E′out (20° C.), the relative dielectric constant of the covering layer, the thickness of the covering layer, and the storage modulus E′c (20° C.) at 20° C. of the covering layer were set as indicated in Table 1.

In Comparative Examples 1 to 3 and Examples 1 to 11, a transponder having a pillar shape was used, and the distance in the tire circumferential direction from the center of the transponder to a splice portion of a tire component was set to 10 mm, and the distance from the cross-sectional center of the transponder to an outer surface of the tire was set to 2 mm or more.

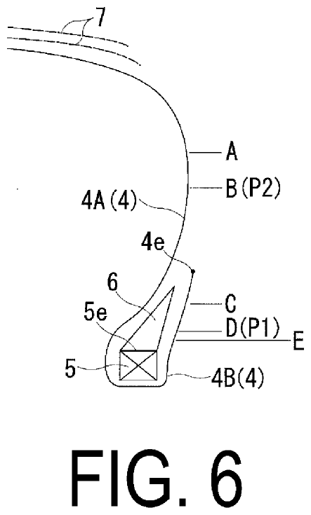

In Table 1, the position in the tire width direction of the transponder being “inner side” means that the transponder is disposed on an inner side in the tire width direction of the carcass layer, and the position in the tire width direction of the transponder being “outer side” means that the transponder is disposed on an outer side in the tire width direction of the carcass layer. Additionally, in Table 1, the position in the tire radial direction of the transponder corresponds to one of positions A to E illustrated in FIG. 6.

Comparative Examples 2 and 3 and Examples 1 to 11 include a rim cushion rubber layer as an outer member. That is, in Table 1, “E′c (20° C.)/E′out (20° C.)” is a ratio of the storage modulus of the covering layer to the storage modulus of the rim cushion rubber layer, which is the outer member. For the sake of convenience, Comparative Example 1 indicates the physical properties of the rim cushion rubber layer as those of the outer member.

These test tires were subjected to tire evaluation (durability) and transponder evaluation (communication performance and durability) according to a test method described below, and the results are indicated together in Table 1.

Durability (Tire and Transponder):

Each of the test tires was mounted on a wheel of a standard rim, and a traveling test was performed by using a drum testing machine at an air pressure of 120 kPa, a maximum load of 102%, and a traveling speed of 81 km/h, and the traveling distance at the time of a failure in the tire was measured. Evaluation results are expressed as index values with Comparative Example 2 being assigned an index value of 100. Larger index values indicate superior tire durability. Further, for each test tire after the end of traveling, whether the transponder was communicable and whether there was damage to the transponder were checked. The results are shown in three levels: “Excellent” means that the transponder was communicable and there was no damage to the transponder; “Good” means that the transponder was communicable but there was damage to the transponder; and “Poor” means that the transponder was not communicable.

Communication Performance (Transponder):

For each test tire, a communication operation with the transponder was performed using a reader/writer. Specifically, the maximum communication distance was measured with the reader-writer set at a power output of 250 mW and a carrier frequency of from 860 MHz to 960 MHz. Evaluation results are expressed as index values with Comparative Example 2 being assigned an index value of 100. Larger index values indicate superior communication performance.

TABLE 1-1

| | | Comparative | Comparative | Comparative | |
|---|---|---|---|---|---|
| | | Example 1 | Example 2 | Example 3 | Example 1 |
| Position in tire width | | Inner side | Outer side | Outer side | Outer side |
| direction of transponder | | | | | |
| Position in tire radial | | C | C | C | C |
| direction of transponder | | | | | |
| E′c(20° C.)/E′out(20° C.) | | 0.8 | 0.05 | 1.6 | 0.8 |
| Relative dielectric | | 8 | 8 | 8 | 8 |
| constant of covering layer | | | | | |
| Thickness of covering layer [mm] | | 0.2 | 0.2 | 0.2 | 0.2 |
| Storage modulus E′c (20° C.) | | 8.0 | 0.6 | 14.0 | 8.0 |
| of covering layer [MPa] | | | | | |
| Tire evaluation | Durability | 100 | 100 | 90 | 105 |
| Transponder | Communication | 85 | 100 | 100 | 100 |
| evaluation | performance | | | | |
| | Durability | Good | Poor | Good | Excellent |

TABLE 1-2

| | | Example 2 | Example 3 | Example 4 | Example 5 | Example 6 |
|---|---|---|---|---|---|---|
| Position in tire width | | Outer side | Outer side | Outer side | Outer side | Outer side |
| direction of transponder | | | | | | |
| Position in tire radial | | E | D | B | A | C |
| direction of transponder | | | | | | |
| E′c(20° C.)/E′out(20° C.) | | 0.8 | 0.8 | 0.8 | 0.8 | 0.8 |
| Relative dielectric | | 8 | 8 | 8 | 8 | 7 |
| constant of covering layer | | | | | | |
| Thickness of covering layer [mm] | | 0.2 | 0.2 | 0.2 | 0.2 | 0.2 |
| Storage modulus E′c (20° C.) | | 8.0 | 8.0 | 8.0 | 8.0 | 8.0 |
| of covering layer [MPa] | | | | | | |
| Tire evaluation | Durability | 105 | 105 | 105 | 103 | 105 |
| Transponder | Communication | 98 | 100 | 100 | 100 | 102 |
| evaluation | performance | | | | | |
| | Durability | Excellent | Excellent | Excellent | Good | Excellent |

TABLE 1-3

| | | Example 7 | Example 8 | Example 9 | Example 10 | Example 11 |
|---|---|---|---|---|---|---|
| Position in tire width | | Outer side | Outer side | Outer side | Outer side | Outer side |
| direction of transponder | | | | | | |
| Position in tire radial | | C | C | C | C | C |
| direction of transponder | | | | | | |
| E′c(20° C.)/E′out(20° C.) | | 0.8 | 0.8 | 0.8 | 0.1 | 1.3 |
| Relative dielectric | | 7 | 7 | 7 | 7 | 7 |
| constant of covering layer | | | | | | |
| Thickness of covering layer [mm] | | 0.5 | 1.0 | 3.0 | 1.0 | 1.0 |
| Storage modulus E′c (20° C.) | | 8.0 | 8.0 | 8.0 | 1.0 | 13.0 |
| of covering layer [MPa] | | | | | | |
| Tire evaluation | Durability | 105 | 105 | 105 | 105 | 105 |
| Transponder | Communication | 104 | 106 | 108 | 106 | 106 |
| evaluation | performance | | | | | |
| | Durability | Excellent | Excellent | Excellent | Good | Good |

Table 1 here indicates that in the pneumatic tires of Examples 1 to 11, as compared to that of Comparative Example 2, the durability of the tire and the communication performance and durability of the transponder were improved in a well-balanced manner.

On the other hand, in Comparative Example 1, the communication performance of the transponder, which was disposed on the inner side in the tire width direction of the carcass layer, degraded. In Comparative Example 3, the value of E′c (20° C.)/E′out (20° C.) was set to be higher than the range specified in the first technology, and this degraded the durability of the tire.

Next, tires according to Comparative Examples 21 to 23 and Examples 21 to 31 were manufactured. The tires are pneumatic tires that have a tire size of 265/40ZR20 and include a tread portion extending in a tire circumferential direction and having an annular shape, a pair of sidewall portions disposed on both sides of the tread portion, and a pair of bead portions disposed on inner sides in a tire radial direction of the sidewall portions, and a carcass layer mounted between the pair of bead portions. The pneumatic tires each have a transponder embedded therein, the transponder being covered with a covering layer. The position in a tire width direction of the transponder, the position in the tire radial direction of the transponder, E′c (20° C.)/E′in (20° C.), the relative dielectric constant of the covering layer, the thickness of the covering layer, and the storage modulus E′c (20° C.) at 20° C. of the covering layer were set as indicated in Table 2.

In Comparative Examples 21 to 23 and Examples 21 to 31, a transponder having a pillar shape was used, and the distance in the tire circumferential direction from the center of the transponder to a splice portion of a tire component was set to 10 mm, and the distance from the cross-sectional center of the transponder to an outer surface of the tire was set to 2 mm or more.

In Table 2, the position in the tire width direction of the transponder being “inner side” means that the transponder is disposed on an inner side in the tire width direction of the carcass layer, and the position in the tire width direction of the transponder being “outer side” means that the transponder is disposed on an outer side in the tire width direction of the carcass layer. Additionally, in Table 2, the position in the tire radial direction of the transponder corresponds to one of positions A to E illustrated in FIG. 6.

Comparative Examples 22, 23 and Examples 21 to 31 includes a bead filler as an inner member. That is, in Table 2, “E′c (20° C.)/E′in (20° C.)” is the ratio of the storage modulus of the covering layer to the storage modulus of the bead filler, which is the inner member. For the sake of convenience, Comparative Example 21 indicates the physical properties of the bead filler as those of the inner member.

These test tires were subjected to tire evaluation (durability) and transponder evaluation (communication performance and durability) according to a test method described below, and the results are indicated together in Table 2.

TABLE 2-1

| | | Comparative | Comparative | Comparative | |
|---|---|---|---|---|---|
| | | Example 21 | Example 22 | Example 23 | Example 21 |
| Position in tire width | | Inner side | Outer side | Outer side | Outer side |
| direction of transponder | | | | | |
| Position in tire radial | | C | C | C | C |
| direction of transponder | | | | | |
| E′c(20° C.)/E′in(20° C.) | | 0.8 | 0.01 | 1.6 | 0.8 |
| Relative dielectric | | 8 | 8 | 8 | 8 |
| constant of covering layer | | | | | |
| Thickness of covering layer [mm] | | 0.2 | 0.2 | 0.2 | 0.2 |
| Storage modulus E′c (20° C.) | | 8.0 | 0.6 | 16.0 | 8.0 |
| of covering layer [MPa] | | | | | |
| Tire evaluation | Durability | 100 | 100 | 90 | 105 |
| Transponder | Communication | 85 | 100 | 100 | 100 |
| evaluation | performance | | | | |
| | Durability | Good | Poor | Good | Excellent |

TABLE 2-2

| | | Example 22 | Example 23 | Example 24 | Example 25 | Example 26 |
|---|---|---|---|---|---|---|
| Position in tire width | | Outer side | Outer side | Outer side | Outer side | Outer side |
| direction of transponder | | | | | | |
| Position in tire radial | | E | D | B | A | C |
| direction of transponder | | | | | | |
| E′c(20° C.)/E′in(20° C.) | | 0.8 | 0.8 | 0.8 | 0.8 | 0.8 |
| Relative dielectric | | 8 | 8 | 8 | 8 | 7 |
| constant of covering layer | | | | | | |
| Thickness of covering layer [mm] | | 0.2 | 0.2 | 0.2 | 0.2 | 0.2 |
| Storage modulus E′c (20° C.) | | 8.0 | 8.0 | 8.0 | 8.0 | 8.0 |
| of covering layer [MPa] | | | | | | |
| Tire evaluation | Durability | 105 | 105 | 105 | 103 | 105 |
| Transponder | Communication | 98 | 100 | 100 | 100 | 102 |
| evaluation | performance | | | | | |
| | Durability | Excellent | Excellent | Excellent | Good | Excellent |

TABLE 2-3

| | | Example 22 | Example 23 | Example 24 | Example 25 | Example 26 |
|---|---|---|---|---|---|---|
| Position in tire width | | Outer side | Outer side | Outer side | Outer side | Outer side |
| direction of transponder | | | | | | |
| Position in tire radial | | E | D | B | A | C |
| direction of transponder | | | | | | |
| E′c(20° C.)/E′in(20° C.) | | 0.8 | 0.8 | 0.8 | 0.8 | 0.8 |
| Relative dielectric | | 8 | 8 | 8 | 8 | 7 |
| constant of covering layer | | | | | | |
| Thickness of covering layer [mm] | | 0.2 | 0.2 | 0.2 | 0.2 | 0.2 |
| Storage modulus E′c (20° C.) | | 8.0 | 8.0 | 8.0 | 8.0 | 8.0 |
| of covering layer [MPa] | | | | | | |
| Tire evaluation | Durability | 105 | 105 | 105 | 103 | 105 |
| Transponder | Communication | 98 | 100 | 100 | 100 | 102 |
| evaluation | performance | | | | | |
| | Durability | Excellent | Excellent | Excellent | Good | Excellent |

Table 2 indicates that in the pneumatic tires of Examples 21 to 31, as compared to that of Comparative Examples 22, the durability of the tire and the communication performance and durability of the transponder were improved in a well-balanced manner.

On the other hand, in Comparative Example 21, the communication performance of the transponder, which was disposed on the inner side in the tire width direction of the carcass layer, degraded. In Comparative Example 23, the value of E′c (20° C.)/E′in (20° C.) was set to be higher than the range specified in the second technology, and this degraded the durability of the tire.

1. A pneumatic tire, comprising:
a tread portion extending in a tire circumferential direction and having an annular shape;
a pair of sidewall portions disposed on both sides of the tread portion;
a pair of bead portions disposed on inner sides in a tire radial direction of the pair of sidewall portions; and
a carcass layer mounted between the pair of bead portions;
a transponder being embedded in an outer side in a tire width direction of the carcass layer, the transponder being covered with a covering layer,
a storage modulus E′c (20° C.) at 20° C. of the covering layer and a storage modulus E′out (20° C.) at 20° C. of a rubber member having the largest storage modulus at 20° C. of rubber members located on an outer side in the tire width direction of the transponder satisfying a relationship 0.1≤E′c (20° C.)/E′out (20° C.)≤1.5.

2. A pneumatic tire, comprising:
a tread portion extending in a tire circumferential direction and having an annular shape;
a pair of sidewall portions disposed on both sides of the tread portion;
a pair of bead portions disposed on inner sides in a tire radial direction of the pair of sidewall portions; and
a carcass layer mounted between the pair of bead portions;
a transponder being embedded in an outer side in a tire width direction of the carcass layer, the transponder being covered with a covering layer,
a storage modulus E′c (20° C.) at 20° C. of the covering layer and a storage modulus E′in (20° C.) at 20° C. of a rubber member having the largest storage modulus at 20° C. of rubber members located on an inner side in the tire width direction of the transponder satisfying a relationship 0.03≤E′c (20° C.)/E′in (20° C.)≤1.50.

3. The pneumatic tire according to claim 1, wherein the storage modulus E′c (20° C.) at 20° C. of the covering layer ranges from 2 MPa to 12 MPa.

4. The pneumatic tire according to claim 1, wherein a relative dielectric constant of the covering layer is 7 or less.

5. The pneumatic tire according to claim 1, wherein the covering layer is formed of rubber or elastomer and 20 phr or more of white filler.

6. The pneumatic tire according to claim 5, wherein the white filler includes 20 phr to 55 phr of calcium carbonate.

7. The pneumatic tire according to claim 1, wherein a center of the transponder is disposed 10 mm or more spaced from a splice portion of a tire component in the tire circumferential direction.

8. The pneumatic tire according to claim 1, wherein the transponder is disposed between a position on an outer side in the tire radial direction by 15 mm of an upper end of a bead core of a bead portion of the pair of bead portions and a tire maximum width position.

9. The pneumatic tire according to claim 1, wherein a distance between a cross-sectional center of the transponder and a tire outer surface is 2 mm or more.

10. The pneumatic tire according to claim 1, wherein a thickness of the covering layer ranges from 0.5 mm to 3.0 mm.

11. The pneumatic tire according to claim 1, wherein the transponder includes an IC (integrated circuit) substrate configured to store data and an antenna configured to transmit and receive data, and the antenna has a helical shape.

12. The pneumatic tire according to claim 2, wherein the storage modulus E′c (20° C.) at 20° C. of the covering layer ranges from 2 MPa to 12 MPa.

13. The pneumatic tire according to claim 2, wherein a relative dielectric constant of the covering layer is 7 or less.

14. The pneumatic tire according to claim 2, wherein the covering layer is formed of rubber or elastomer and 20 phr or more of white filler.

15. The pneumatic tire according to claim 14, wherein the white filler includes 20 phr to 55 phr of calcium carbonate.

16. The pneumatic tire according to claim 2, wherein a center of the transponder is disposed 10 mm or more spaced from a splice portion of a tire component in the tire circumferential direction.

17. The pneumatic tire according to claim 2, wherein the transponder is disposed between a position on an outer side in the tire radial direction by 15 mm of an upper end of a bead core of a bead portion of the pair of bead portions and a tire maximum width position.

18. The pneumatic tire according to claim 2, wherein a distance between a cross-sectional center of the transponder and a tire outer surface is 2 mm or more.

19. The pneumatic tire according to claim 2, wherein a thickness of the covering layer ranges from 0.5 mm to 3.0 mm.

20. The pneumatic tire according to claim 2, wherein the transponder includes an IC substrate configured to store data and an antenna configured to transmit and receive data, and the antenna has a helical shape.
